(19) United States
(12) Patent Application Publication
(10) Pub. No.: US 2016/0331118 A1
(43) Pub. Date: Nov. 17, 2016

(54) Roller Brush Assembly

(71) Applicant: Willis Gerald Major, Rochester, NY (US)

(72) Inventor: Willis Gerald Major, Rochester, NY (US)

(21) Appl. No.: 14/701,018

(22) Filed: May 12, 2015

(51) Int. Cl. A46B 15/00; B25G 1/04; B05C 17/02; A46B 5/02

(52) U.S. Cl. CPC A46B 15/00; A46B 5/02; B25G 1/04; B05C 17/02

(57) ABSTRACT

A painting applicator that comprises a paint roller cover and a paint brush whereas said paint brush is internally aligned along the same axis as said paint roller cover, whereby said painting applicator has two modes of alignment whereby in paint roller mode said paint brush is internally enclosed by said paint roller cover and while in paint brush mode said paint brush is external to said paint roller cover, whereby when in said paint roller mode only said paint roller cover acts on a surface to roll paint against said surface without said paint brush interfering with the surface and when in said paint brush mode said paint brush is external to said paint roller cover whereby when in said paint brush mode said paint brush acts upon a surface to brush paint onto said surface and said paint roller cover can also act on a surface.

### CROSS-REFERENCE TO RELATED APPLICATIONS

This non-provisional application claims the benefits and priority filing date of provisional application No. 61988693 filed on 5 may 2014.

### BACKGROUND

1. Field of Invention

This invention relates to painting tools that are used to paint, stain, dust, polish, strip, sand, clean, wipe off & apply chemicals (liquid and powder) to the surface area of objects comprising of bars, posts, poles, shafts, spindles, railings, and columns in addition to flat surfaces such as walls.

2. Description of Prior Art

The popular method of painting, staining, dusting, polishing, striping, cleaning, wiping off & applying chemicals to the surface area of multisided objects is to use a standard brush that has a handle at one end and brush material pointing 180 degrees straight out of the opposite end of handle or using a standard paint roller that has a handle located 90 degree to the roller cover. With the current methods one is restricted to holding a painting tool at one angle which is limiting when you are painting a multisided object. Some painting tools have adjustable rollers to paint multisided objects but when there is an interior corner or a deep groove to be painted or stained one must put down the roller and pick up a paint brush to use to get into the corner or groove. My invention is different from other inventions in that there is no need to switch back and forth between a paint roller and paint brush. My invention combines a paint roller cover with a paint brush making it possible to roll paint on a surface and also brush paint on a surface with the same painting tool.

### SUMMARY

In accordance with the present invention, the “roller brush assembly” mainly comprises a paint roller cover and a paint brush which is connected internal to the paint roller cover. A paint brush that starts off being internal to a roller cover and then being actuated so that said paint brush is external to said roller cover is the novelty of said present invention. This invention allows the operator to roll paint on walls or flat objects with the paint roller cover while the paint brush is internal to the paint roller cover so as not to interfere with the painting job and allows the operator to apply paint into grooves and corners with the paint brush when the paint brush is external to the paint roller cover. This invention can be used to more efficiently paint, stain, dust, polish, strip, sand, clean, wipe off & apply liquid and power chemicals to multiple painting objects.

### Objects and Advantages

Accordingly, several objects and advantages of the “roller brush assembly” described in my above patent are:
(a) to provide a more efficient way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(b) to provide an easier way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(c) to provide a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(d) to provide a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(e) to provide a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

Further objectives and advantages of my invention will become apparent from a consideration of the drawings and ensuing description.

### DRAWING FIGURES

In accordance with the present invention the “roller brush assembly” mainly comprises a paint roller cover and a paint brush connected internal to the paint roller cover.

FIG. 1) shows the “roller brush assembly” with an external paint brush.

FIG. 2) shows the “roller brush assembly” with an internal paint brush.

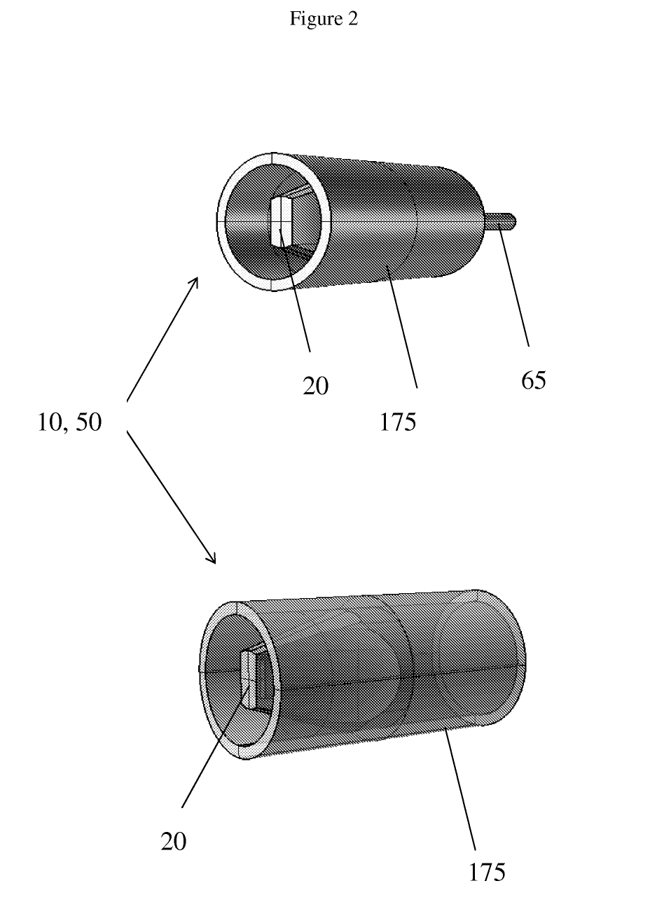

FIG. 3) shows the “roller brush assembly” as an adjustable paint applicator with the roller cover adjusted to 90 & 180 degrees in relation to the handle.

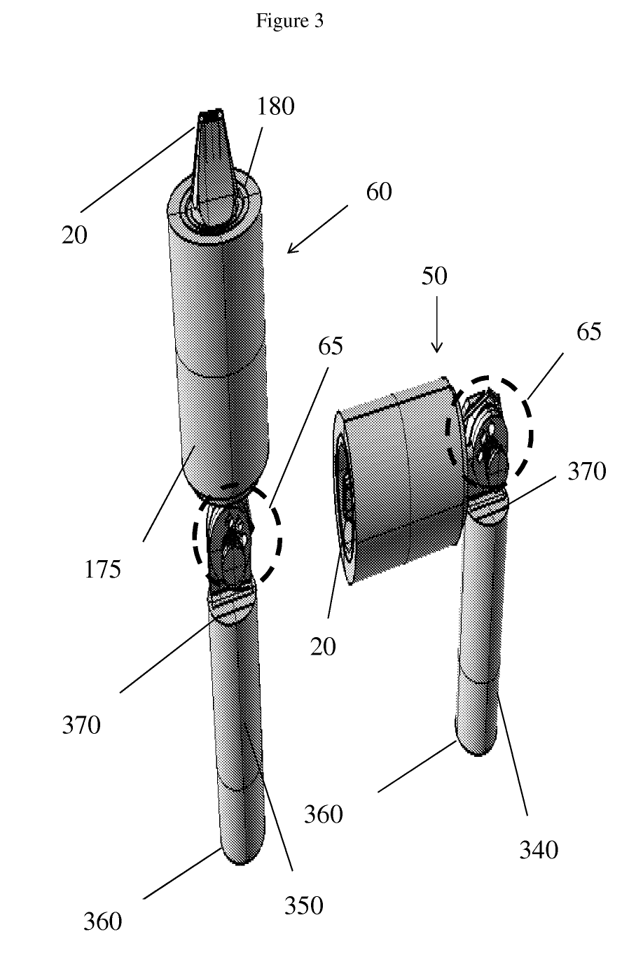

FIG. 4) shows the “roller brush assembly” paint brush head extend and retract mechanism

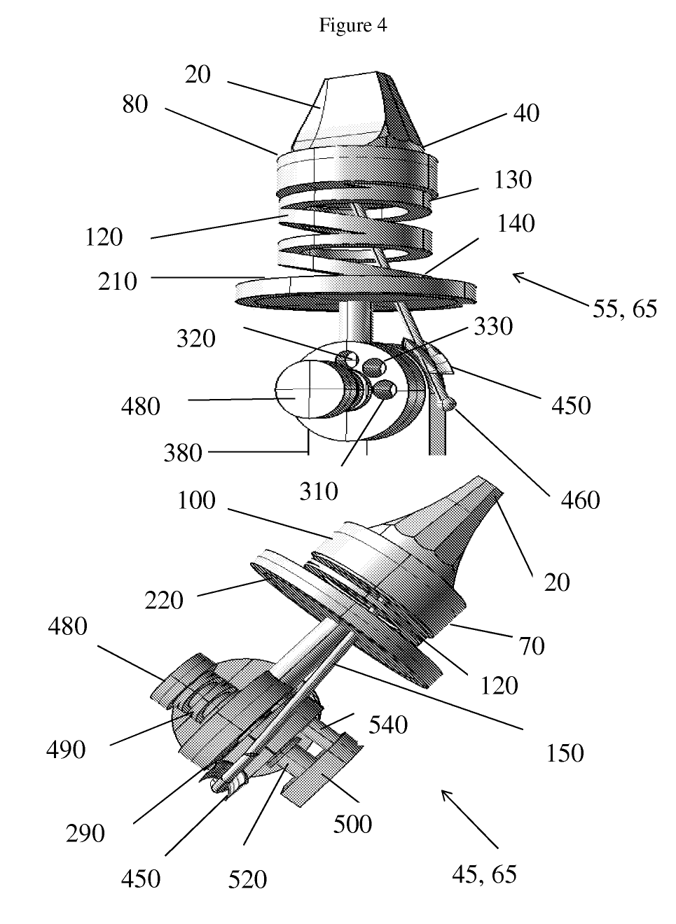

FIG. 5) shows the “roller brush assembly” position adjustment and locking mechanism

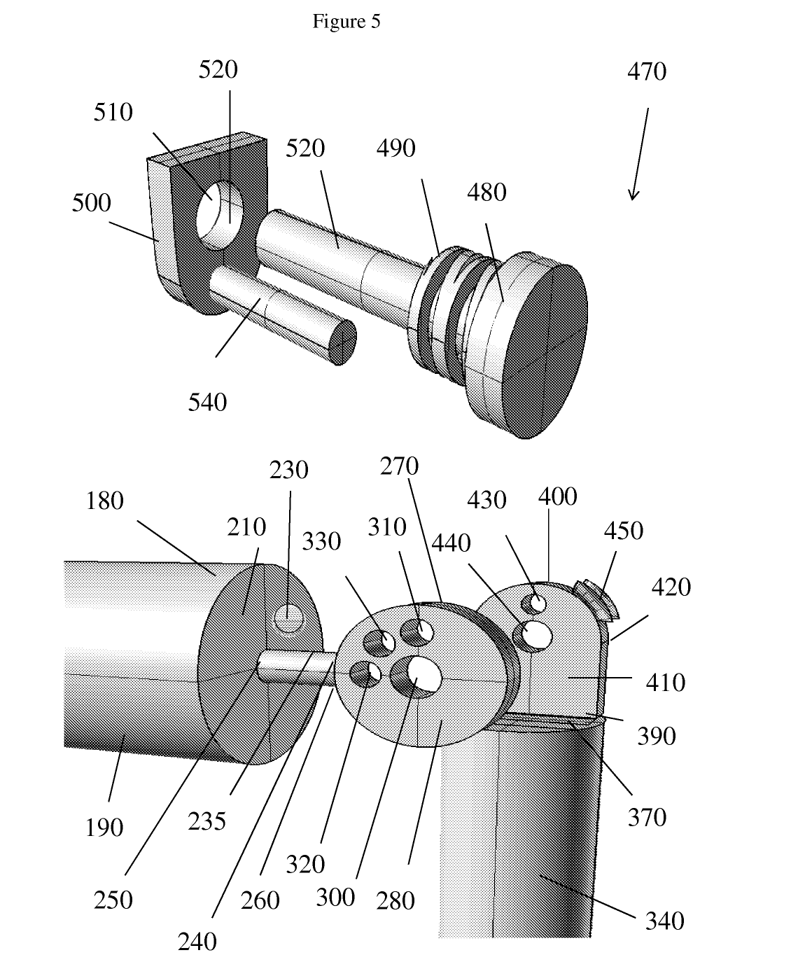

FIG. 6) shows the “roller brush assembly” paint brush sliding cup and roller cover cylindrical mounting frame views

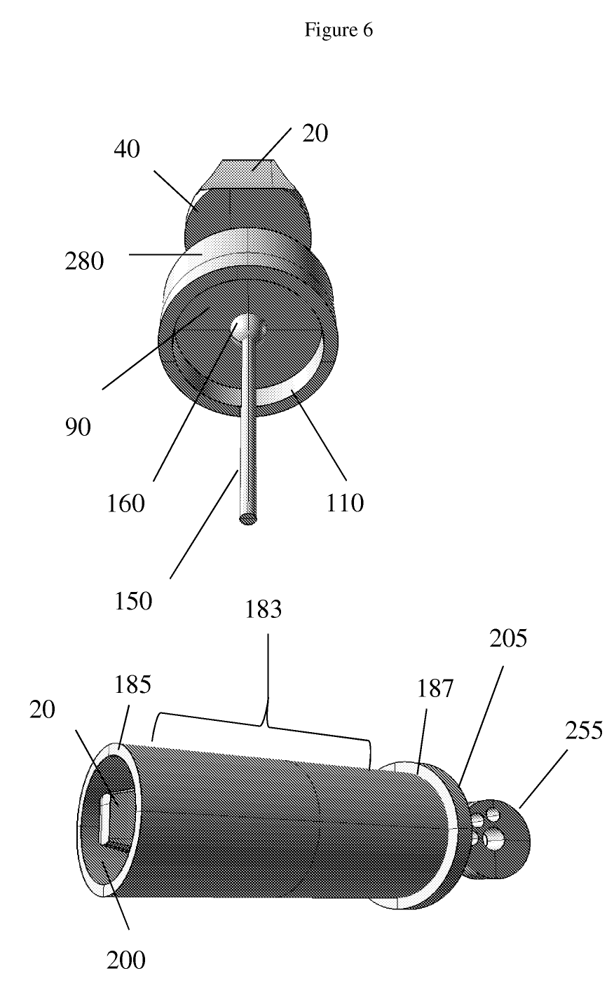

### REFERENCE NUMERALS IN DRAWINGS

10 roller brush assembly

20 paint brush head

40 paint brush head base

45 paint brush head retracted

50 paint brush head internal to paint roller cover

55 paint brush head extended

60 paint brush head external to paint roller cover

65 paint brush head extend and retract mechanism

70 paint brush sliding cup

80 paint brush sliding cup outer plate surface

90 paint brush sliding cup inner plate surface

100 paint brush sliding cup outer diameter

110 paint brush sliding cup inner diameter

120 paint brush activation spring

130 paint brush activation spring top

140 paint brush activation spring bottom

150 paint brush activation wire

160 paint brush activation wire left end

170 paint brush activation wire right end

175 paint roller cover

176 paint roller cover left side

177 paint roller cover right side

178 paint roller cover inner diameter

179 paint roller cover outer diameter

180 roller cover cylindrical mounting frame

183 roller cover cylindrical mounting frame roller body section

185 roller cover cylindrical mounting frame top

187 roller cover cylindrical mounting frame bottom

190 roller cover cylindrical mounting frame outer diameter

200 roller cover cylindrical mounting frame body inner diameter

205 roller cover cylindrical mounting frame plate

210 roller cover cylindrical mounting frame inner plate surface

220 roller cover cylindrical mounting frame outer plate surface

230 roller cover cylindrical mounting frame wire hole

235 roller cover cylindrical mounting frame shaft

240 roller cover cylindrical mounting frame shaft left end

250 roller cover cylindrical mounting frame shaft right end

255 roller cover cylindrical mounting frame disc

260 roller cover cylindrical mounting frame disc left side

270 roller cover cylindrical mounting frame disc top side

280 roller cover cylindrical mounting frame disc front side

290 roller cover cylindrical mounting frame disc back side

300 roller cover cylindrical mounting frame disc center attachment hole

310 roller cover cylindrical mounting frame disc 90 degree position hole

320 roller cover cylindrical mounting frame disc 180 degree position hole

330 roller cover cylindrical mounting frame disc 135 degree position hole

340 handle

350 handle gripping section

360 handle bottom

370 handle top

380 handle attachment disc

390 handle attachment disc bottom

400 handle attachment disc top

410 handle attachment disc front

420 handle attachment disc back

430 handle attachment disc position hole

440 handle attachment disc center attachment hole

450 handle attachment disc activation wire holding channel

460 handle attachment disc activation wire attachment

470 position adjustment and locking mechanism

480 position adjustment and locking mechanism bolt

490 position adjustment and locking mechanism spring

500 position adjustment and locking mechanism retainer

510 position adjustment and locking mechanism retainer attachment hole

520 position adjustment and locking mechanism retainer attachment threads

540 position adjustment and locking mechanism retainer position pin

### DESCRIPTION

Preferred Roller Brush Assembly

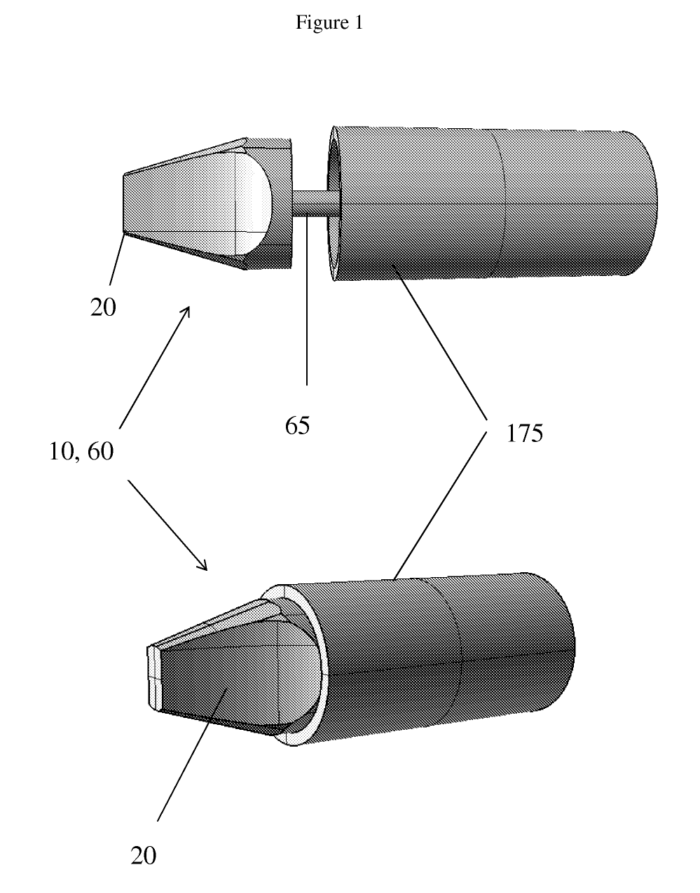

A first preferred embodiment of the “roller brush assembly 10” is illustrated in FIG. 1. The “roller brush assembly” main parts generally comprise of a paint brush head 20, and a paint roller cover 175, joined together whereas the paint brush head 20, is internally connected to the paint roller cover 175. The roller brush assembly 10, has two positions wherein the first position the paint brush head 20, is fully internal to the paint roller cover 175, during paint roller only use applications and in the other position the paint brush head 20, is fully extended external to the paint roller cover when the paint brush is ready to be used. A position adjustment mechanism 65, is used to adjust the location of the paint brush external or internal to the paint roller cover 175. The paint brush head 20, is made up of a plurality of materials comprising foam, cloth, horse hair and other materials that general paint brush bristles are made out of, but foam is the preferred material. The paint roller cover 175, is made up of a plurality of materials comprising foam, cloth and other materials that general paint roller covers are made out of with foam being the preferred material.

Advantages

From the description above, a number of advantages of the “roller brush assembly” have become evident:
(f) provides a more efficient way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(g) provides an easier way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(h) provides a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(i) provides a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(j) provides a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

Operation (Roller Brush Assembly)

The first step would be to determine what application the “roller brush assembly” is going to be used in. This would determine which roller cover or brush material you needed. If you were painting, staining, dusting, polishing, striping, cleaning, wiping off & applying chemicals (liquid and powder), drying, sanding, or scraping, each of these different operations would require you to pick out a different roller or brush material for that specific operation. Once you have decided what material you need for the specific job, you would then be ready to start using the “roller brush assembly”. In FIG. #1, an operator would take the roller brush assembly and push it onto a paint roller frame shaft that slide in and out allowing said paint brush head to move internally and external in and out of said paint roller cover. When the paint brush head is internal to the paint roller cover the operator will roller the paint roller cover on a flat surface to apply paint like all typical paint rollers but when there is a groove or interior corner to be painted the paint brush is moved external to the paint roller cover by way of the position adjustment mechanism so that the paint brush head can be used to brush paint onto a surface like a typical paint brush. The roller brush assembly allows the operator to use a paint brush and paint roller in one tool just by adjusting the paint brush to an internal or external position relative to the paint roller cover.

Conclusions, Ramifications, and Scope

Accordingly, the reader will see that the “roller brush assembly” of this invention has advantages in that
(a) it provides a more efficient way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(b) it provides an easier way of painting, staining, dusting, polishing, striping, sanding, cleaning, wiping off or applying chemicals (liquid and powder) to objects comprising bars, posts, poles, shafts, spindles, railings, supports, walls and columns but not limiting to the aforementioned group of objects;
(c) it provides a simple way paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(d) it provides a reduction in the number of people require to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;
(e) it provides a better way to paint, stain, dust, polish, strip, sand, clean, wipe off & apply chemicals (liquid and powder) to multisided objects comprising bars, posts, poles, shafts, spindles, railings, supports, and columns but not limiting to the aforementioned group of objects;

Further objectives and advantages of my invention will become apparent from a consideration of the drawings and ensuing description. Although the description above contains much specificity, these should not be construed as limiting the scope of the invention but as merely providing illustrations of some of the presently preferred embodiments of the invention. Thus the scope of the invention should be determined by the appended claims and their legal equivalents, rather than just by the examples given.

I claim:

1) A painting applicator that comprises a paint roller cover and a paint brush head whereby said paint roller cover comprises a paint roller cover outer diameter, a paint roller cover inner diameter, a paint roller cover left side, and a paint roller cover right side, whereby said paint brush head is internally aligned inside of said paint roller cover inner diameter and either extends out of said paint roller cover or retracts inside of said paint roller cover, whereas as said paint brush head extends out of paint roller cover said paint brush head moves from paint roller cover right side to paint roller cover left side causing said paint brush to extend out of the paint roller cover left side to become external to said paint roller cover, whereby paint brush head can be used to brush paint on a surface and when paint brush head is moved in the opposite direction from paint roller cover left side to paint roller cover right side, said paint brush head is retracted internally to said paint roller cover inner diameter allowing said paint brush head to sit inside of paint roller cover in an internally enclosed and retracted state thus allowing said paint roller to roll paint on a surface without said paint brush head interfering.

2) The claim of 1, whereby a paint brush head extend & retract mechanism is used to force said painting brush head to retract inside of said paint roller cover inner diameter making said paint brush internally enclose by said paint roller cover and used to force said paint brush head external to paint roller cover left side and out of the inner diameter of said paint roller cover.

3) The claim of 1, wherein the said paint roller cover and said paint brush head are made of materials comprising foam, cloth, horse hair, plastic fibers, hair, high density foam, plastic, and other material that is use to apply paint, stain, liquid and power chemicals.

4) The claim of 1 wherein said paint roller cover and said paint brush head are made within one single unit to make up the complete said painting applicator.

5) The claim of 1 wherein said paint roller cover and said paint brush head are made within two separate units, whereby the paint roller cover is separate from the paint brush head but installed on the same applicator.

6) I claim a painting applicator comprising a paint roller cover, a paint brush head, a paint brush extend & retract mechanism, a roller cover mounting frame, a handle and a position adjustment and locking mechanism, wherein said roller cover mounting frame comprises of a frame top, a frame bottom, a frame outer diameter, a frame inner diameter, a frame inner plate surface, a frame outer plate surface, a frame wire hole, a frame shaft left end, a frame shaft right end, a frame disc left side, a frame disc right side, a frame disc front, a frame disc back, a frame disc center attachment hole, a frame disc 90 degree position hole, a frame disc 180 degree position hole, and a frame disc 135 degree position hole, said paint roller cover comprises a cover left side, a cover right side, a cover outer diameter and a cover inner diameter, whereby said cover inner diameter is slid over said frame outer diameter allowing said cover right side to contact said frame inner plate surface, said paint brush head extend and retract mechanism comprises a sliding cup, a sliding cup outer plate surface, a sliding cup inner plate surface, a sliding cup outer diameter, a sliding cup inner diameter, an activation spring, an activation spring top, an activation spring bottom, activation wire, an activation wire left end, and an activation wire right end, said paint brush head comprises of a paint brush base whereby said sliding cup outer plate surface is connected to said paint brush head base, said activation wire left end is connected to said slinging cup inner plate surface, while said activation spring top sits in said sliding cup inner diameter, and said activation spring bottom contacts said frame inner plate surface and said sliding cup outer diameter rides along said frame inner diameter when said paint brush head is extended outside of said frame inner diameter and retracted inside of said frame inner diameter, said handle comprises of a handle gripping section, a handle bottom, a handle top, an attachment disc, an attachment disc bottom, an attachment disc top, an attachment disc front, an attachment disc back, an attachment disc position hole, an attachment disc center attachment hole, an attachment disc activation wire holding channel, and an attachment disc activation wire attachment, said activation wire right end goes through said frame wire hole and rest inside of said attachment disc activation wire holding channel and is connected to said attachment disc at said attachment disc activation wire attachment at said attachment disc top, said position and locking mechanism comprises a locking mechanism bolt, a locking mechanism spring, a locking mechanism retainer, a locking mechanism retainer attachment hole, a locking mechanism retainer attachment threads, and a locking mechanism retainer position pin, said locking mechanism bolt goes through said locking mechanism spring and then through said frame disc center attachment hole and then through attachment disc center attachment hole and is secured by the locking mechanism retainer attachment threads, whereby said locking mechanism retainer position pin goes through attachment disc position hole and through frame disc 90 degree position hole to retract said paint brush head inside of the frame inner diameter to allow said paint roller cover to roll paint on a surface and said locking mechanism retainer position pin goes through attachment disc position hole and through frame disc 180 degree position hole to extend said paint brush head outside of said frame inner diameter allowing said paint brush head to brush paint on a surface.

7) The claim of 6 wherein said paint roller cover and said paint brush head are disposable foam attachable and detachable components of said paint applicator.

8) The claim of 6 whereby when said activation wire pulls said sliding cup against said activation spring top and contracts said activation spring against said frame inner plate surface, as said activation wire wraps around the top of said attachment disc top and locking mechanism retainer position pin goes through attachment disc position hole and through frame disc 90 degree position hole to retract said paint brush head inside of the frame inner diameter and whereby when locking mechanism retainer position pin goes through attachment disc position hole and through frame disc 180 degree position hole to extend said paint brush head outside of said frame inner diameter said activation wire separates from part of the attachment disc top and releases the force of the activation spring to allow the paint brush head to extend outside of said frame inner diameter.

9) The claim of 6, wherein said paint roller cover and said paint brush are made of materials comprising foam, cloth, horse hair, plastic fibers, hair, high density foam, plastic, and other material that is use to apply paint, stain, liquid and power chemicals.

10) I claim a hand tool comprising a roller with an enclosed tool centrally aligned with the axis of said roller, whereby said enclosed tool is positioned external or internal to said roller by way of a positioning mechanism moving said enclosed tool internal or external to said roller, whereby when only said roller is being used said enclosed tool is positioned internal to said roller and when only said enclosed tool is being used then said enclosed tool is exposed and positioned external to said roller.

11) The claim of 10 wherein said hand tool is attached to a handle by way of a connection means comprising a retainer clip, press-fit, screwed, threaded, bolted, wire & spring assembly.

12) The claim of 10 whereby said hand tool has a dual purpose in which one purpose is to act upon a surface by rolling on said surface with said roller and said other purposed is when said enclosed tool is external to said roller to act on a surface with said enclosed tool after it is extended outside of the inner diameter of said roller.
